(19) United States
(12) Patent Application Publication
(10) Pub. No.: US 2007/0263099 A1
(43) Pub. Date: Nov. 15, 2007

(54) Ambient Light Rejection In Digital Video Images

(75) Inventors: Ricardo J. Motta, Palo Alto, CA (US); Ting Chen, Milpitas, CA (US); Douglas K. Tao, San Jose, CA (US); Joseph D. Montalbo, Menlo Park, CA (US)

Correspondence Address: PATENT LAW GROUP LLP, 2635 NORTH FIRST STREET, SUITE 223, SAN JOSE, CA, 95134, US

(73) Assignee: PIXIM INC., Mountain View, CA (US)

(21) Appl. No.: 11/460,884

(22) Filed: Jul. 28, 2006

Related U.S. Application Data
(60) Provisional application No. 60/746,815, filed on May 9, 2006.

(51) Int. Cl. H04N 5/228

(52) U.S. Cl. 348/222.1

(57) ABSTRACT

A method for generating an ambient light rejected output image includes providing a sensor array including a two-dimensional array of digital pixels where the digital pixels output digital signals as digital pixel data representing the image of the scene, capturing a pair of images of a scene within the time period of a video frame using the sensor array where the pair of images includes a first image being illuminated by ambient light and a second image being illuminated by the ambient light and a light source, storing the digital pixel data associated with the first and second images in a data memory, and subtracting the first image from the second image to obtain the ambient light rejected output image.

### CROSS-REFERENCE TO RELATED APPLICATION

This application claims the benefit of U.S. Provisional Patent Application Ser. No. 60/746,815, filed on May 9, 2006, having the same inventorship hereof, which application is incorporated herein by reference in its entirety.

### FIELD OF THE INVENTION

The invention relates to digital video imaging and, in particular, to a method and a system for implementing ambient light rejection in digital video images.

### DESCRIPTION OF THE RELATED ART

A digital imaging system for still or motion images uses an image sensor or a photosensitive device that is sensitive to a broad spectrum of light to capture an image of a scene. The photosensitive device reacts to light reflected from the scene and can translate the strength of that light into electronic signals that are digitized. Generally, an image sensor includes a two-dimensional array of light detecting elements, also called pixels, and generates electronic signals, also called pixel data, at each light detecting element that are indicative of the intensity of the light impinging upon each light detecting element. Thus, the sensor data generated by an image sensor is often represented as a two-dimensional array of pixel data.

Digital imaging systems are often applied in computer vision or machine vision applications. Many computer vision and machine vision applications require detection of a specific scene and objects in the scene. To ensure detection accuracy, it is crucial that lighting conditions and motion artifacts in the scene does not affect the detection of the image object. However, in many real life applications, lighting changes and motions in the scenes are unavoidable. Ambient light rejection has been developed to overcome the effect of lighting condition changes and motion artifacts in video images for improving the detection accuracy of objects in machine vision applications.

Ambient light rejection refers to an imaging technique whereby active illumination is used to periodically illuminate a scene so as to enable the cancellation of the ambient light in the scene. The scene to be captured can have varying lighting conditions, from darkness to artificial light source to sunlight. Traditional ambient light rejection uses active illumination together with multiple captures where a scene is captured twice, once under the ambient lighting condition and the other under the same ambient lights and a controlled external light source. This is often referred to as the “sequential frame ambient light rejection” method and is illustrated in FIG. 1. As shown in FIG. 1, a first image capture (Frame A) is made when there is no active illumination and a second image capture (Frame B) is made when active illumination, such as from an infrared light source, is provided. Frame A and frame B are sequential frames of video images. When the difference between the two image frames is taken, an output image that is illuminated under only the controlled external light source results. The ambient or surrounding light is thereby removed.

The conventional ambient light rejection imaging systems have many disadvantages. Traditional imaging systems implementing ambient light rejection are typically limited by the imaging system's capture speed so that the multi image capture is limited to the frame rate and only sequential frame ambient light rejection is possible. Sequential frame ambient light rejection technique can suffer from motion artifacts especially when there are high speed motions in the scene. Also, these imaging systems can be very computational intensive and often require large amount of memory to implement.

Furthermore, the conventional ambient light rejection imaging systems often have low signal-to-noise ratio so that a strong active light source is required. Using strong IR illumination to overwhelm the ambient light is not practical in some applications because of risk of eye injury and expense.

An imaging system enabling the implementation of ambient light rejection for a variety of lighting conditions and high speed motion in the scene is desired.

### SUMMARY OF THE INVENTION

According to one embodiment of the present invention, a method for generating an ambient light rejected output image includes providing a sensor array including a two-dimensional array of digital pixels where the digital pixels output digital signals as digital pixel data representing the image of the scene, capturing a pair of images of a scene within the time period of a video frame using the sensor array where the pair of images includes a first image being illuminated by ambient light and a second image being illuminated by the ambient light and a light source, storing the digital pixel data associated with the first and second images in a data memory, and subtracting the first image from the second image to obtain the ambient light rejected output image.

The present invention is better understood upon consideration of the detailed description below and the accompanying drawings.

### BRIEF DESCRIPTION OF THE DRAWINGS

FIG. 1 is a timing diagram illustrating the sequential frames ambient light rejection technique.

FIG. 2 is a block diagram illustrating a digital imaging system implementing ambient light rejection according to one embodiment of the present invention.

FIG. 3 is a timing diagram illustrating the intra-frame image capture scheme for implementing ambient light rejection according to one embodiment of the present invention.

FIG. 4 is a timing diagram illustrating a typical image capture operation of a DPS array.

FIG. 5 is a timing diagram illustrating the image capture operation of a DPS array implementing intra-frame image capture according to one embodiment of the present invention.

FIG. 6 is a timing diagram illustrating the multiple intra-frame image capture scheme for implementing ambient light rejection in the digital imaging system according to another embodiment of the present invention.

FIG. 7 is a timing diagram illustrating the anti-jamming intra-frame image capture scheme for implementing ambient light rejection in the digital imaging system according to one embodiment of the present invention.

FIG. 8 is a timing diagram illustrating the negative illumination intra-frame image capture scheme for implementing ambient light rejection in the digital imaging system according to one embodiment of the present invention.

FIG. 9 is a block diagram of a digital image sensor as described in U.S. Pat. No. 5,461,425 of Fowler et al.

FIG. 10 is a functional block diagram of an image sensor as described in U.S. Pat. No. 6,975,355 of Yang et al.

FIG. 11 is a diagram illustrating the frame differencing method using a look-up table according to one embodiment of the present invention.

FIG. 12 illustrates the generation of the LUT output data value for each N-bit data input value according to one embodiment of the present invention.

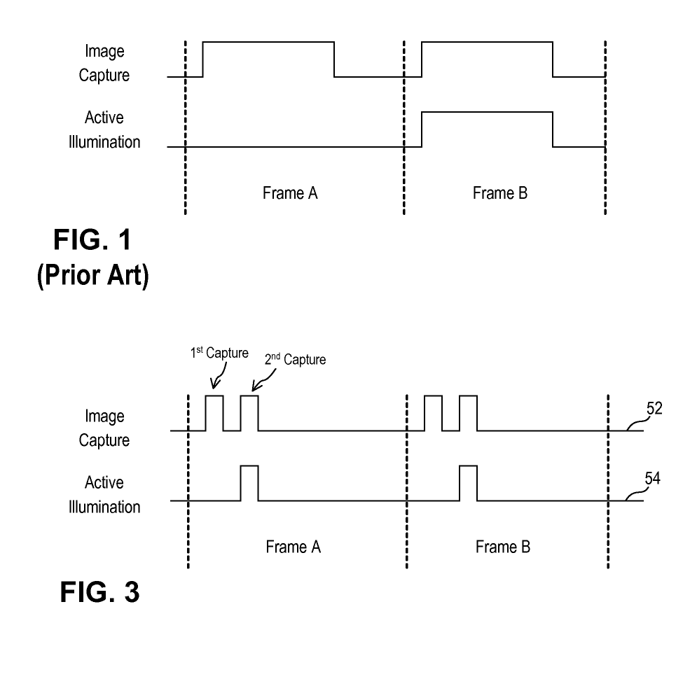

### DETAILED DESCRIPTION OF THE PREFERRED EMBODIMENTS

In accordance with the principles of the present invention, a digital imaging system implementing ambient light rejection using active illumination utilizes a digital pixel sensor to realize a high speed intra-frame capture rate. The active illumination is implemented using an external light source under the control of the digital imaging system to provide synchronized active illumination. The digital imaging system performs multiple captures of the scene to capture at least one ambient lighted image and at least one active-and-ambient lighted image within a video frame. The difference of the ambient lighted image and the active-and-ambient lighted image is obtained to generate an output image where the ambient light component of the image is removed and only the active illuminated component of the image remains. The digital imaging system provides high quality and high resolution ambient rejected images under a wide range of lighting conditions and fast motions in the scene.

The digital imaging system of the present invention exploits the massively parallel analog-to-digital conversion capability of a digital pixel sensor to realize a high capture rate. Furthermore, multiple sampling can be applied to improve the dynamic range of the final images. In this manner, the digital imaging system of the present invention generates high resolution ambient light rejected images while avoiding many of the disadvantages of the conventional methods.

More specifically, by using a digital pixel sensor to realize a very high image capture rate, the digital imaging system can capture a pair of ambient lighted and active-and-ambient lighted images in rapid succession so as to minimize the impact of lighting changes or motions in the scene. That is, each ambient lighted or active-and-ambient lighted image can be captured at a high capture speed and the pair of images can be captured as close in time as possible, with minimal delay between the ambient lighted and the active illuminated image captures. When the ambient lighted image and the active-and-ambient lighted image are capture in close temporal proximity, the two images can be in registration, or aligned, with each other so that ambient cancellation can be carried out effectively and a high resolution ambient rejected output image is obtained.

In particular, when the digital imaging system is applied in a video imaging application, the digital imaging system can carry out multiple image captures within the standard video frame rate (e.g., 60 frames per second or 16 ms per frame). By performing multiple intra-frame image captures, each pair of ambient light and active-and-ambient lighted images can be taken in close temporal proximity to avoid the impact of lightning changes or motions in the scene.

Furthermore, the digital imaging system of the present invention is capable of realizing a very high ambient light rejection ratio. In many applications, due to safety and power consumption concerns, the amount of light generated by the external light source is limited. When the light provided by the external light source is weak, it becomes challenging to distinguish the active-illuminated component of an image in the presence of bright ambient light, such as direct sunlight. The digital imaging system of the present invention achieves high ambient light rejection ratio by minimizing the exposure time while increasing the peak external light source power. Because the digital imaging system is capable of a fast capture rate, the digital imaging system can operate with the shorter exposure time while obtaining still providing a high resolution image. When the peak external light source power is increased, the duty cycle of the imaging system is shortened to maintain the total power consumption over time.

System Overview

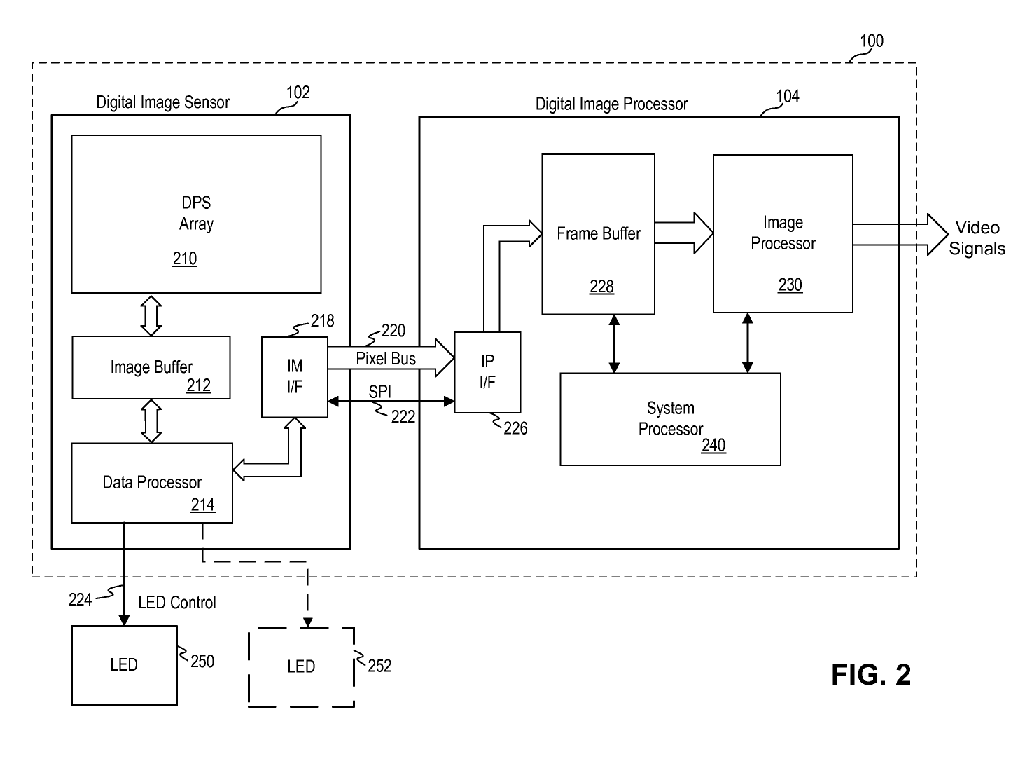

FIG. 2 is a block diagram illustrating a digital imaging system implementing ambient light rejection according to one embodiment of the present invention. Referring to FIG. 2, a digital imaging system 100 in accordance with the present embodiment is implemented as a video imaging system. In other embodiments, digital imaging system 100 can be implemented as a still image camera or a motion and still image camera. Digital imaging system 100 includes a digital image sensor subsystem 102 and a digital image processor subsystem 104. Digital image sensor subsystem 102 and digital image processor subsystem 104 can be formed on a single integrated circuit or each subsystem can be formed as an individual integrated circuit. In other embodiments, the digital image sensor subsystem and the digital image processor subsystem can be formed as a multi-chip module whereby each subsystem is formed as separate integrated circuits on a common substrate. In the present embodiment, digital image sensor subsystem 102 and digital image processor subsystem 104 are formed as two separate integrated circuits. In the present description, the terms “digital image sensor 102” and “digital image processor 104” will be used to refer to the respective subsystems of digital imaging system 100. The use of the terms “digital image sensor 102” and “digital image processor 104” are not intended to limit the implementation of the digital imaging system of the present invention to two integrated circuits only.

Digital image sensor 102 is an operationally “stand-alone” imaging subsystem and is capable of capturing and recording image data independent of digital image processor 104. Digital image sensor 102 operates to collect visual information in the form of light intensity values using an area image sensor, such as sensor array 210, which includes a two-dimensional array of light detecting elements, also called photodetectors. Sensor array 210 collects image data under the control of a data processor 214. At a predefined frame rate, image data collected by sensor array 210 are read out of the photodetectors and stored in an image buffer 212. Typically, image buffer 212 includes enough memory space to store at least one frame of image data from sensor array 210.

In the present embodiment, data processor 214 of digital image sensor 102 provides a control signal on a bus 224 for controlling a light source 250 external to digital imaging system 100 to provide controlled active illumination. In this manner, data processor 214 asserts the control signal whenever active illumination is desired to enable an image capture in synchronous with the active illumination. In the present embodiment, the external light source is a light emitting diode (LED) and data processor 214 provides an LED control signal to cause LED 250 to turn on when active illumination is required. In other embodiments, the external light source can be other suitable light source, such as infrared (IR) illumination.

Image data recorded by digital image sensor 102 is transferred through an image sensor interface circuit (IM I/F) 218 to digital image processor 104. In the present embodiment, digital image sensor 102 and digital image processor 104 communicate over a pixel bus 220 and a serial peripheral interface (SPI) bus 222. Pixel bus 220 is uni-directional and serves to transfer image data from digital image sensor 102 to digital image processor 104. SPI bus 222 is a bi-directional bus for transferring instructions between the digital image sensor and the digital image processor. In digital imaging system 100, the communication interface between digital image sensor 102 and digital image processor 104 is a purely digital interface. Therefore, pixel bus 220 can implement high speed data transfer, allowing real time display of images captured by digital image sensor 102.

In one embodiment, pixel bus 220 is implemented as a low-voltage differential signaling (LVDS) data bus. By using a LVDS data bus, very high speed data transfer can be implemented. Furthermore, in one embodiment, SPI bus 222 is implemented as a four-wire serial communication and serial flash bus. In other embodiments, SPI bus 222 can be implemented as a parallel bi-directional control interface.

Digital image processor 104 receives image data from digital image sensor 102 on pixel bus 220. The image data is received at an image processor interface circuit (IP I/F) 226 and stored at a frame buffer 228. Digital image processor 104, operating under the control of system processor 240, performs digital signal processing functions on the image data to provide output video signals in a predetermined video format. More specifically, the image data stored in frame buffer 228 is processed into video data in the desired video format through the operation of an image processor 230. In one embodiment, image processor 230 is implemented in part in accordance with commonly assigned and copending U.S. patent application Ser. No. 10/174,868, entitled “A Multi-Standard Video Image Capture Device Using A Single CMOS Image Sensor,” of Michael Frank and David Kuo, filed Jun. 16, 2002 (the '868 application), which application is incorporated herein by reference in its entirety. For example, image processor 230 can be configured to perform vertical interpolation and/or color interpolation (“demosaicing”) to generate full color video data, as described in the '868 application.

In accordance with the present invention, image processor 230, under the command of system processor 240, also operates to perform ambient light cancellation between a pair of ambient lighted and active-and-ambient lighted images, as will be described in more detail below.

In one embodiment, digital imaging system 100 is implemented using the video imaging system architecture described in commonly assigned and copending U.S. patent application Ser. No. 10/634,302, entitled “Video Imaging System Including A Digital Image Sensor and A Digital Signal Processor,” of Michael Frank et al., filed Aug. 4, 2003, which application is incorporated herein by reference in its entirety.

The output video signals generated by image processor 230 can be used in any number of ways depending on the application. For example, the signals can be provided to a television set for display. The output video signals can also be fed to a video recording device to be recorded on a video recording medium. When digital imaging system 100 is a video camcorder, the TV signals can be provided to a viewfinder on the camcorder.

In the present description, digital imaging system 100 generates video signals in either the NTSC video format or the PAL video format. However, this is illustrative only and in other embodiments, digital imaging system 100 can be configured to support any video formats, including digital television, and any number of video formats, as long as image processor 230 is appropriately configured, as described in details in the aforementioned '868 application.

The detail structure and operation of digital imaging system 100 for implementing ambient light rejection will now be described with reference to FIG. 2 and the remaining figures.

Digital Image sensor

Digital imaging system 100 uses a single image sensor to capture video images which are then processed into output video data in the desired video formats. Specifically, digital image sensor 102 includes a sensor array 210 of light detecting elements (also called pixels) and generates digital pixel data as output signals at each pixel location. Digital image sensor 102 also includes image buffer 212 for storing at least one frame of digital pixel data from sensor array 210 and data processor 214 for controlling the capture and readout operations of the image sensor. Data processor 214 also controls the external light source 250 for providing active illumination. Digital image sensor 102 may include other circuitry not shown in FIG. 2 to support the image capture and readout operations of the image sensor.

In the present embodiment, sensor array 210 of digital image sensor 102 is implemented as a digital pixel sensor (DPS). A digital pixel sensor refers to a CMOS image sensor with pixel level analog-to-digital conversion capabilities. A CMOS image sensor with pixel level analog-to-digital conversion is described in U.S. Pat. No. 5,461,425 of B. Fowler et al. (the '425 patent), which patent is incorporated herein by reference in its entirety. A digital pixel sensor provides a digital output signal at each pixel element representing the light intensity value detected by that pixel element. The combination of a photodetector and an analog-to-digital (A/D) converter in an area image sensor helps enhance detection accuracy, reduce power consumption, and improves overall system performance.

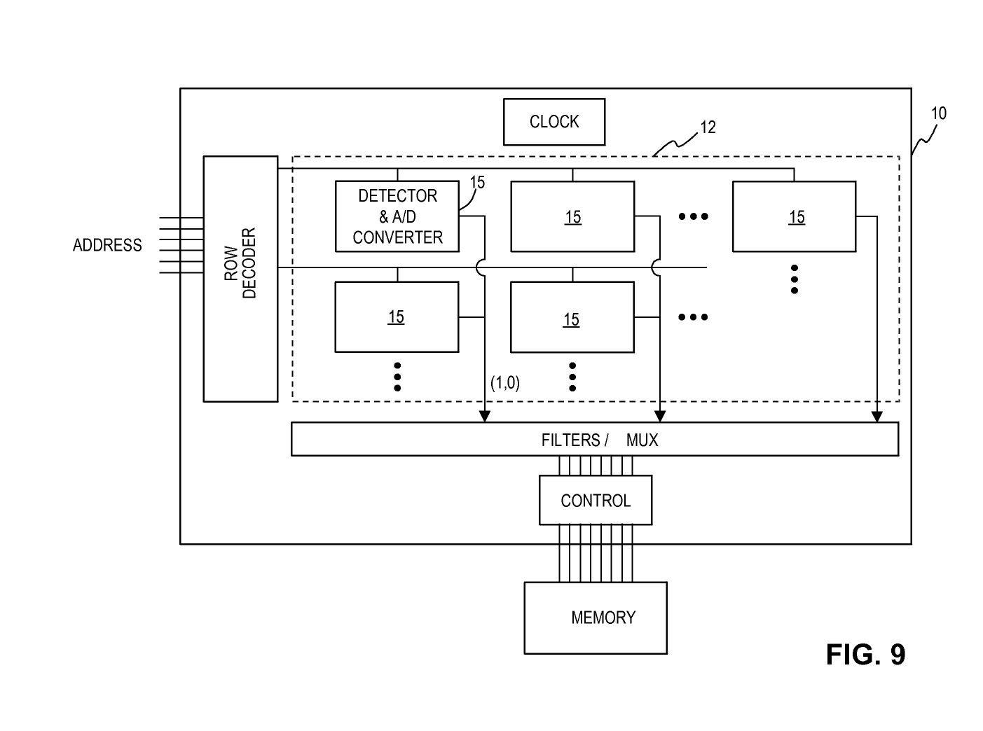

In the present description, a digital pixel sensor (DPS) array refers to a digital image sensor having an array of photodetectors where each photodetector produces a digital output signal. In one embodiment of the present invention, the DPS array implements the digital pixel sensor architecture illustrated in FIG. 9 and described in the aforementioned '425 patent. The DPS array of the '425 patent utilizes pixel level analog-to-digital conversion to provide a digital output signal at each pixel. The pixels of a DPS array are sometimes referred to as a “sensor pixel” or a “sensor element” or a “digital pixel,” which terms are used to indicate that each of the photodetectors of a DPS array includes an analog-to-digital conversion (ADC) circuit, and is distinguishable from a conventional photodetector which includes a photodetector and produces an analog signal. The digital output signals of a DPS array have advantages over the conventional analog signals in that the digital signals can be read out at a much higher speed than the conventional image sensor. Of course, other schemes for implementing a pixel level A/D conversion in an area image sensor may also be used in the digital image sensor of the present invention.

In the digital pixel sensor architecture shown in FIG. 9, a dedicated ADC scheme is used. That is, each of pixel elements 15 in sensor array 12 includes an ADC circuit. The image sensor of the present invention can employ other DPS architectures, including a shared ADC scheme. In the shared ADC scheme, instead of providing a dedicated ADC circuit to each photodetector in a sensor array, an ADC circuit is shared among a group of neighboring photodetectors. For example, in one embodiment, four neighboring photodetectors may share one ADC circuit situated in the center of the four photodetectors. The ADC circuit performs A/D conversion of the output voltage signal from each photodetectors by multiplexing between the four photodetectors. The shared ADC architecture retains all the benefits of a pixel level analog-to-digital conversion while providing the advantages of consuming a much smaller circuit area, thus reducing manufacturing cost and improving yield. Above all, the shared ADC architecture allows a higher fill factor so that a larger part of the sensor area is available for forming the photodetectors.

In one embodiment of the present invention, the ADC circuit of each digital pixel or each group of digital pixels is implemented using the Multi-Channel Bit Serial (MCBS) analog-to-digital conversion technique described in U.S. Pat. No. 5,801,657 B. Fowler et al. (the '657 patent), which patent is incorporated herein by reference in its entirety. The MCBS ADC technique of the '657 patent can significantly improve the overall system performance while minimizing the size of the ADC circuit. Furthermore, as described in the '657 patent, a MCBS ADC has many advantages applicable to image acquisition and more importantly, facilitates high-speed readout.

In another embodiment of the present invention, the ADC circuit of each digital pixel or each group of digital pixels implements a thermometer-code analog-to-digital conversion technique with continuous sampling of the input signal for achieving a digital conversion with a high dynamic range. A massively parallel thermometer-code analog-to-digital conversion scheme is described in copending and commonly assigned U.S. patent application Ser. No. 10/185,584, entitled “Digital Image Capture having an Ultra-high Dynamic Range,” of Justin Reyneri et al., filed Jun. 26, 2002, which patent application is incorporated herein by reference in its entirety.

Returning to FIG. 2, in the present embodiment, digital image sensor 102 includes image buffer 212 as an on-chip memory for storing at least one frame of pixel data. However, in other embodiments, digital image sensor 102 can also operate with an off-chip memory as the image buffer. The use of on-chip memory is not critical to the practice of the present invention. The incorporation of an on-chip memory in a DPS sensor alleviates the data transmission bottleneck problem associated with the use of an off-chip memory for storage of the pixel data. In particular, the integration of a memory with a DPS sensor makes feasible the use of multiple sampling for improving the quality of the captured images. Multiple sampling is a technique capable of achieving a wide dynamic range in an image sensor without many of the disadvantages associated with other dynamic range enhancement techniques, such as degradation in signal-to-noise ratio and increased implementation complexity. U.S. Pat. No. 6,975,355, entitled “Multiple Sampling via a Time-indexed Method to Achieve Wide Dynamic Ranges,” of David Yang et al., issued Dec. 13, 2005, describes a method for facilitating image multiple sampling using a time-indexed approach. The '355 patent is incorporated herein by reference in its entirety.

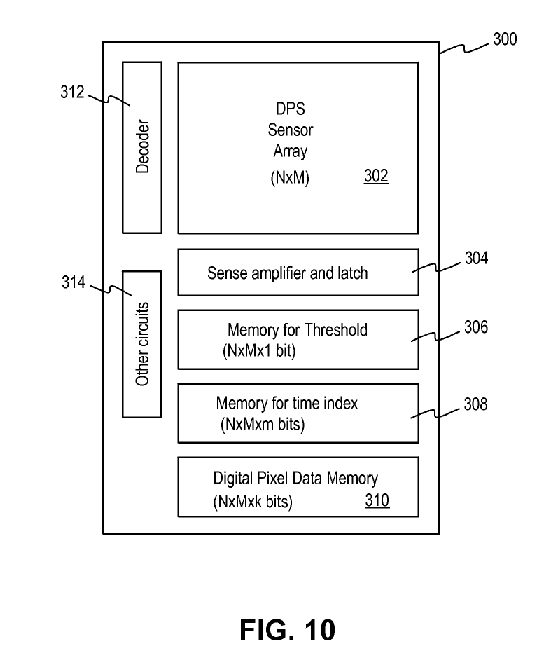

FIG. 10 duplicates FIG. 3 of the '355 patent and shows a functional block diagram of an image sensor 300 which may be used to implement digital image sensor 102 in one embodiment. The operation of image sensor 300 using multiple sampling is described in detail in the '355 patent. Image sensor 300 includes a DPS sensor array 302 which has an N by M array of pixel elements. Sensor array 302 employs either the dedicated ADC scheme or the shared ADC scheme and incorporates pixel level analog-to-digital conversion. A sense amplifier and latch circuit 304 is coupled to sensor array 302 to facilitate the readout of digital signals from sensor array 302. The digital signals (also referred to as digital pixel data) are stored in digital pixel data memory 310. To support multiple sampling, image sensor 300 also includes a threshold memory 306 and a time index memory 308 coupled to sensor array 302. Threshold memory 306 stores information of each pixel indicating whether the light intensity value measured by each pixel in sensor array 302 has passed a predetermined threshold level. The exposure time indicating when the light intensity measured by each pixel has passed the threshold level is stored in time index memory 308. As a result of this memory configuration, each pixel element in sensor array 302 can be individually time-stamped by threshold memory 306 and time index memory 308 and stored in digital pixel data memory 310. A DPS image sensor employing multiple sampling is capable of recording 14 to 16 or more bits of dynamic range in the captured image, in contrast with the 10 bits of dynamic range attainable by conventional image sensors. In the present embodiment, digital image sensor 102 is a DPS image sensor and is implemented using the architecture of image sensor 300 of FIG. 10 to support multiple sampling for attaining a high dynamic range in image capture.

In the present embodiment, digital image sensor 102 implements correlated double sampling for noise reduction. Correlated double sampling (CDS) is an image processing technique employed to reduce kT/C or thermal noise and 1/f noise in an image sensor array. CDS can also be employed to compensate for any fixed pattern noise or variable comparator offset. To implement CDS, the sensor array is reset and the pixel values at each photodetector is measured and stored in specified memory locations in the data memory (image buffer 212). The pixel value measured at sensor array reset is called “CDS values” or “CDS subtract values.” Subsequently, for each frame of pixel data captured by the sensor array 210, the stored CDS values are subtracted from the measured pixel intensity values to provide normalized pixel data free of errors caused by noise and offset.

Digital Image Processor

Digital image processor 104 is a high performance image processor for processing pixel data from digital image sensor 102 into video images in a desired video format. In the present embodiment, digital image processor 104 implements signal processing functions for supporting an entire video signal processing chain. Specifically, the image processing functions of digital image processor 104 include demosaicing, image scaling, and other high-quality video enhancements, including color correction, edge, sharpness, color fidelity, backlight compensation, contrast, and dynamic range extrapolation. The image processing operations are carried out at video rates.

The overall operation of digital image processor 104 is controlled by system processor 240. In the present embodiment, system processor 240 is implemented as an ARM (Advanced RISC Machine) processor. Firmware for supporting the operation of system processor 240 can be stored in a memory buffer. A portion of frame buffer 228 may be allocated for storing the firmware used by system processor 240. System processor 240 operates to initialize and supervise the functional blocks of image processor 104.

In accordance with the present invention, digital image processor 104 also facilitate image capture operations for obtaining pairs of ambient lighted and active-and-ambient lighted images and processing the pairs of images to generate output images with ambient light cancellation. The operation of digital image system 100 for implementing ambient light rejection in the output video signals will be described in more detail below.

Ambient Light Rejection Using Intra-Frame Image Capture

FIG. 3 is a timing diagram illustrating the intra-frame image capture scheme for implementing ambient light rejection according to one embodiment of the present invention. Referring to FIG. 3, a signal line 52 represents the image capture operation of digital imaging system 100 while a signal line 54 represents the active illumination control. In the present illustration, a logical “low” level of signal lines 52 and 54 indicates respectively no image capture operation or the active illumination being turned off while a logical “high” level indicates respectively an image capture operation or the active illumination being turned on.

In accordance with one embodiment of the present invention, an intra-frame image capture scheme is implemented to obtain a pair of ambient lighted and active-and-ambient lighted images, successively captured in close temporal proximity, within a single video frame image of a scene. As shown in FIG. 3, a first image capture is carried out without active illumination to generate a first image with only ambient lighting. Then a second image capture is carried out with active illumination to generate a second image with active and ambient lighting. Both the first and second captures occur within a single video frame and the fast image capture is made possible by the high capture speed operation of digital image sensor 102. Digital image processor 104 operates to subtract the first image from the second image to provide an ambient rejected output image. The image subtraction is performed pixel by pixel. According to another aspect of the present invention, an image subtraction method utilizing a look-up table is used to provide a fast and simple way to perform the image frame subtraction, as will be described in more detail below.

In FIG. 3, the active illuminated image capture is carried out after the ambient lighted image capture. The order of the two image captures is not critical to the practice of the present invention and in other embodiments and the active illuminated image capture can be carried out before the ambient lighted image capture. It is only critical that a pair of ambient light and active-and-ambient lighted images is obtained in close temporal proximity to each other.

The intra-frame capture scheme provides significant advantages over the conventional sequential frame capture technique. First, by capturing the pair of ambient lighted and active-and-ambient lighted images within a video frame and in close temporal proximity to each other, the correlation of the two images improves significantly so that the completeness of the ambient light cancellation is greatly improved. Furthermore, by capturing the pair of images within close temporal proximity, image artifacts due to motions in the scene are greatly reduced. Finally, because of the high speed operation of digital image sensor 102, digital imaging system 100 can provide an increased output frame rate to improve the resolution of the output video signals. In one embodiment, digital imaging system 100 is used for continuous video monitoring at a full video rate (e.g., 60 frames per second) and for motion in a scene moving at extreme speed (e.g. over 120 mph or 200 kph).

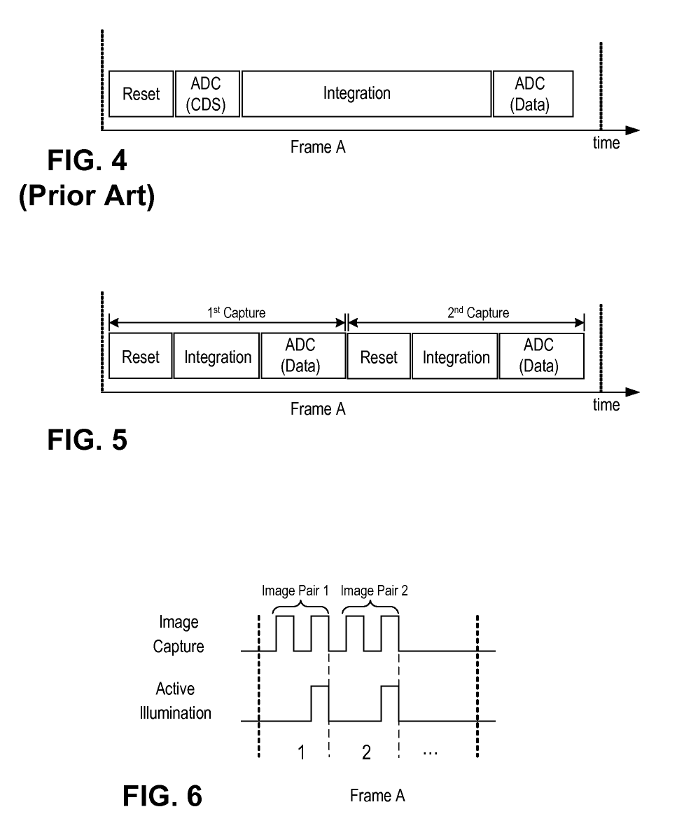

The detail of the image capture operation will now be described with reference to FIGS. 4 and 5. FIG. 4 is a timing diagram illustrating a typical image capture operation of a DPS array. FIG. 5 is a timing diagram illustrating the image capture operation of a DPS array implementing intra-frame image capture according to one embodiment of the present invention.

Referring first to FIG. 4, in a typical image capture operation, within the time period of a single video frame ( 1/60 sec. or 16.67 ms), a DPS array first performs a sensor array reset operation and then the DPS array performs analog-to-digital conversion (ADC) to read out pixel data values for CDS. Then, image integration starts and the DPS array is exposed to the scene for a given exposure time. Each digital pixel integrates incident light impinging upon the DPS array. A mechanical shutter or an electronic shutter can be used to control the exposure time. Following image integration, the DPS array performs analog-to-digital conversion to read out pixel data values representing the image of the scene. The CDS data values and the image data values are stored in the image buffer and can be processed on-chip or off-chip to provide the normalized pixel data values.

Referring now to FIG. 5, in accordance with one embodiment of the present invention, the intra-fame image capture scheme of the present invention implements a fast image capture operation where two fast image captures are performed within the time period of a single video frame ( 1/60 sec.). In the present embodiment, a fast image capture includes a reset operation, an image integration operation and an ADC data readout operation. As shown in FIG. 5, within the time of a single video frame, a first fast image capture and a second fast image capture are carried out. One of the two fast image captures is synchronized with the activation of the external light source.

In the fast image capture scheme used in FIG. 5, the CDS operation is eliminated. This is because when performing ambient light cancellation, only the difference between the two images is important. Therefore, pixel data errors due to offset or noise will affect both images equally and most errors will be cancelled out when the ambient light component is removed from the final image. By eliminating the CDS operation, the capture time for each image capture can be shortened so that two fast image captures can fit within the time of a single video frame rate.

More importantly, the two fast image captures of FIG. 5 can be carried out with zero or minimal delay between each capture so that the two captures can be of nearly the same identical scene. In one embodiment, the ADC operation is carried out using a single-capture-bit-serial (SCBS) conversion scheme or the MCBS conversion scheme described above and an exposure time of 120 μs can be used for each image capture. Thus, two captures can be completed in a time that is a fraction of 1 ms. By using such a high speed of image capture, digital imaging system 100 can have a high tolerance on ambient lighting changes as well as fast motions in the scene.

Multi Intra-Frame Capture

In the above described embodiment, the intra-frame capture scheme for ambient light cancellation is carried out by taking a single ambient lighted image and a single active-and-ambient lighted image within a single video frame. According to another aspect of the present invention, the intra-frame capture scheme of the present invention is extended to perform multiple intra-frame image capture for ambient light cancellation. The multiple intra-frame image capture scheme has the advantage of increasing the total integration time without incorporating undesirable motion artifacts.

FIG. 6 is a timing diagram illustrating the multiple intra-frame image capture scheme for implementing ambient light rejection in the digital imaging system according to another embodiment of the present invention. Referring to FIG. 6, within a single video frame (Frame A), multiple sets of image captures are carried out to generate multiple pairs of ambient and active-and-ambient lighted images. Each pair of ambient and active-and-ambient lighted images is subtracted from each other to generate a difference output image containing only the active illuminated component of the scene. Then, the difference output images of all image pairs are summed to provide a final ambient rejected output image.

The multiple intra-frame image capture scheme is particularly advantageous when the illumination provided by the external light source is limited so that a longer exposure time is desired to integrate the active illuminated image sufficiently. However, if the integration time alone is extended, the ambient light rejection ratio will be adversely affected and there will be more motion artifacts in the resulting image because the image integration was extended over a longer period of time. The multiple image capture scheme of the present invention increases the effective integration time without creating motion induced artifacts as each pair of ambient lighted and active-and-ambient lighted images are taken within close temporal proximity to each other.

Anti-Jamming

In a digital imaging system using active illumination to implement ambient light rejection, it is possible to defeat the imaging system by sensing the periodic active illumination and providing additional “jamming” illumination. The jamming illumination would be synchronized to the active illumination and shifted to illuminate the subject of interest when the active illumination is not active. When image subtraction is carried out, the subject as well as the ambient light will be rejected, rendering the output image meaningless.

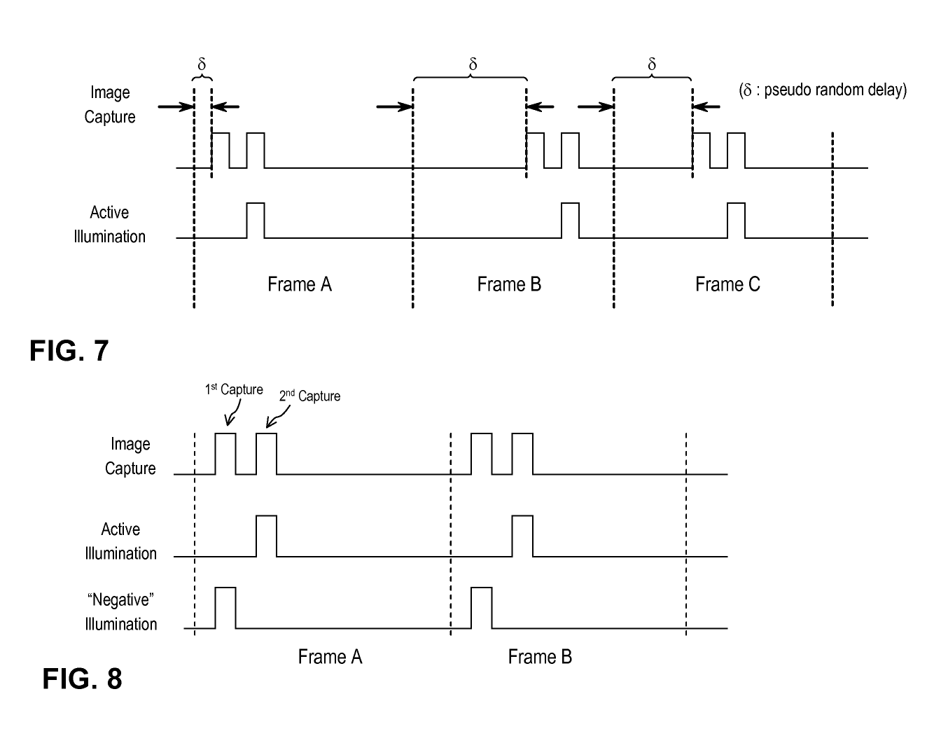

According to one aspect of the present invention, a jamming resistant intra-frame image capture scheme is implemented in the digital imaging system of the present invention to prevent the digital imaging system from being jammed and rendered ineffective. FIG. 7 is a timing diagram illustrating the jamming resistant intra-frame image capture scheme for implementing ambient light rejection in the digital imaging system according to one embodiment of the present invention. Referring to FIG. 7, a pseudo random delay “δ” is included between the start of each frame and the start of the first image capture. In this manner, the pair of image captures occurs at a pseudo random delay time from the start of each video frame and the active illumination will also be provided in a pseudo random manner. By shifting the image capture time in a pseudo random manner within the video frame, the intra-frame image capture scheme of the present invention is thereby provided with jamming resistant capability. It is now no longer possible for a jamming device to use a simple phase locked loop to lock in and synchronize to the active illumination.

Negative Illumination

In some applications, the digital imaging system of the present invention is provided to capture a scene with a large field of view. In that case, it is sometimes desirable to block out part of the view, so as to provide privacy or to remove parts of the scene that are not of interest and are “distracting” to human or machine scene interpretation. In accordance with another aspect of the present invention, the intra-frame image capture scheme for ambient light rejection is implemented using a second controlled light source to provide a second source of illumination to portions of the scene that are to be blocked out. This second source of illumination to limited portions of the scene is referred herein as “negative” illumination. When the “negative” illumination is applied in the intra-frame image capture scheme as described below, the portions of the scene illuminated by the negative illumination will appear black in the final ambient rejected output image and those portions of the scene are thereby blocked out in the final output image.

FIG. 8 is a timing diagram illustrating the negative illumination intra-frame image capture scheme for implementing ambient light rejection in the digital imaging system according to one embodiment of the present invention. Referring to FIG. 8, a digital imaging system implements ambient light rejection by taking a first image capture with only ambient lighting and a second image capture with active illumination with both image capture occurring within a single video frame, in the same manner as described above. However, in accordance with the present embodiment, in addition to the first external light source (such as LED 250 of FIG. 2) providing the active illumination to the entire scene, the digital imaging system is equipped with a second external light source (such as LED 252 of FIG. 2) providing a second source of illumination to selected portions of the scene. The second external light source 252 is also under the control of data processor 214 of digital image sensor 102 of the digital imaging system to be synchronized with the image captures of the image sensor. LED 252 is situated so that the second external light source is directed to only selected portions of the field of view of digital image sensor 102 desired to be blocked out.

The second external light source 252 is synchronized to the first image capture of digital image sensor 102. Referring now to FIG. 8, the second external light source 252 is activated in synchronous with the first image capture to provide a source of illumination to the selected portions of the scene during the first image capture. Those selected portions of the scene are thus illuminated by the ambient light as well as the “negative” illumination from the second external light source. The remaining portions of the scene are illuminated by the ambient light only. Then, at the second image capture, the first external light source is activated to provide active illumination to the entire scene.

As a result, the first image capture provides a first image with the entire scene being ambient lighted and portions of the scene also lit by the “negative” illumination. The second image capture provides a second image with the entire scene being ambient lighted and active illuminated. When the first image is subtracted from the second image, the portions of the scene that are illuminated by the “negative” illumination will appear black and those portions of the scene are thus blocked out in the final ambient rejected output image.

To ensure complete cancellation, the level of “negative” illumination should match the ambient cancellation illumination for the selected parts of the scene to black out the image. The ambient cancellation illumination refers to the active illumination used to reject the ambient light and used to generate the ambient rejected output image. In one embodiment, the level of “negative” illumination is determined by using saturated arithmetic in the subtraction process and making sure that the negative illumination component is greater than the active illumination component used for ambient cancellation. In another embodiment, the level of “negative” illumination is determined by using a feedback loop to ensure that the relevant part of the scene to be blacked out possesses neither positive nor “negative” brightness.

Applications

The digital imaging system of the present invention implementing ambient light rejection using active illumination and high speed intra-frame image capture can be advantageously applied to many applications. In one embodiment, the digital imaging system is applied in an automobile for driver face monitoring. For instance, the digital imaging system can be used to capture images of the driver's face to determine if the driver may be falling asleep. The driver face monitoring application can also be used to identify the driver where the driver identification can be used to automatically set up the seat or mirror position preferences for the driver. The driver face monitoring application can also be extended for use in face recognition or monitoring of users of automatic teller machines. The face monitoring application can also be used as biometrics for access control.

In an automobile, sun and artificial lights are always in motion and can come into the automobile at any angle with varying intensity. This varying light condition makes it difficult to use conventional imaging to capture the driver's face as the image may be too dark or too bright. It is also impractical to use strong IR illumination to overwhelm the ambient light because of risk of eye injury to the driver. However, with the use of the ambient light rejection technique of the present invention, an image of the driver illuminated only with the controlled active illumination, which can be a low power light source, is obtained to allow reliable and consistent capture of the driver's face image for further image processing.

The digital imaging system of the present invention can also be applied to image objects formed using a retro-reflective medium. A retro-reflective medium refers to reflective medium which provide high levels of reflectance along a direction back toward the source of illuminating radiation. Automobile license plates are typically formed with retro-reflection. The digital imaging system of the present invention can be applied to capture automobile license plates or other objects with retro-reflection. The digital imaging system can provide ambient-rejected images of the objects regardless of the lighting conditions or the motion the objects are subjected to.

The applications of the digital imaging system of the present invention are numerous and the above-described applications are illustrative only and are not intended to be limiting.

Frame Differencing Using Look-up Table

In the digital imaging system described above, two images are obtained and they need to be subtracted from each other to obtain the ambient rejected output image. The operation of subtracting two frames is referred to as frame differencing. Typically, frame differencing is performed using dedicated circuitry such as an adder circuit. Adding an adder circuit to the digital imaging system increases the complexity and cost of the system.

According to one aspect of the present invention, the digital imaging system of the present invention implements frame differencing using a decoder look-up table (LUT). In this manner, the frame differencing can be carried out without additional circuitry for pixel data subtraction. Furthermore, linearizing of the pixel data can be carried out at the same time as the frame subtraction to further improve the speed of operation of the digital imaging system.

As described above with reference to FIG. 2, digital imaging system 100 includes digital image sensor 102 for capturing and storing pixel data indicative of the image of a scene. Digital image sensor 102 includes a memory buffer 212 for storing at least one frame of pixel data where each pixel data is allocated N bits of memory space. For implementing the intra-frame image capture scheme for ambient light rejection, image buffer 212 can include sufficient memory to store at least two frames of pixel data so that the pair of ambient lighted and active-and-ambient lighted images can be stored in image buffer 212 at the same time.

In accordance with the frame differencing scheme of the present invention, image buffer 212 allocates N bits for storing pixel data for each pixel and each of the ambient lighted and active-and-ambient lighted images is stored using N/2 bits of memory. The combined N bits of pixel data of the ambient light image and active-and-ambient lighted images are used to index a look-up table. The output pixel data value from the look-up table is the difference between the ambient light image and active-and-ambient lighted images. The output pixel data value may also be linearized so that the linearization and the subtraction steps are combined in one look-up table operation.

One advantage of the frame differencing scheme of the present invention is that the frame differencing scheme can be implemented using memory space required for only one frame of N-bit image data, resulting space and cost savings. In this manner, the digital imaging system of the present invention can use the same memory space to provide N-bit pixel data when the ambient light rejection is not selected and to provide N/2-bit pixel data when ambient light rejection is selected. In one embodiment, image buffer 212 stores pixel data in 12 bits and each of the ambient lighted and active-and-ambient lighted images is stored in 6 bits.

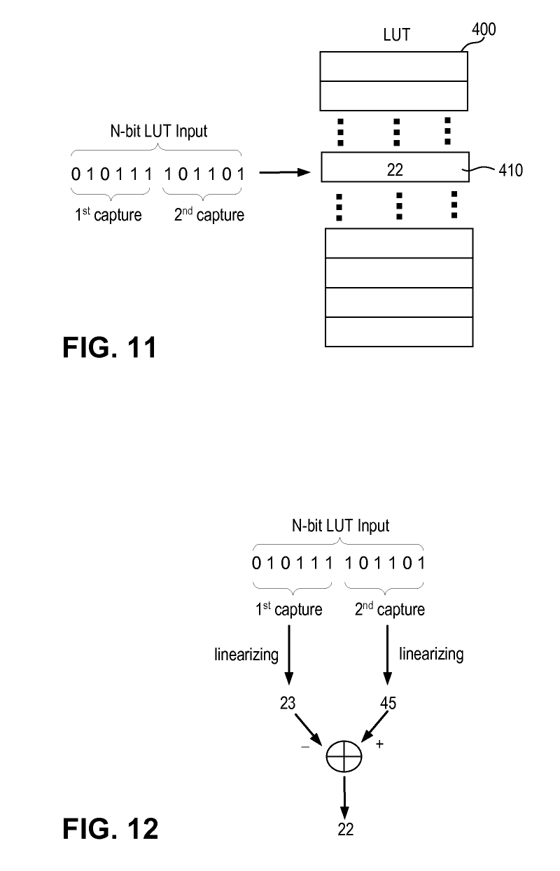

FIG. 11 is a diagram illustrating the frame differencing method using a look-up table according to one embodiment of the present invention. Referring to FIG. 11, a look-up table (LUT) 400 is generated where the LUT is indexed by an N-bit data input representing the N/2-bit pixel data associated with the two image captures of a pixel element. The LUT provides output data values indicative of the pixel value difference of the two image captures for that pixel element. Furthermore, in the present embodiment, the LUT 400 is generated using linearized pixel data values so that the output data values provided by the LUT represent linearized frame difference pixel data values.

In one embodiment, LUT 400 is indexed by a 12-bit data input. As described above, the 12-bit data input represents a 12-bit pixel data pair formed by combining the 6-bit pixel data of a pixel element from the first image capture and the 6-bit pixel data of the same pixel element from the second image capture. The first and second image captures refer to the ambient lighted and active-and-ambient lighted images. In the present embodiment, LUT 400 includes 4096 entries where each entry is uniquely associated with a 12-bit pixel data pair. The generation of the output data values of LUT 400 for each 12-bit pixel data pair is described with reference to FIG. 12.

FIG. 12 illustrates the generation of the LUT output data value for each N-bit data input value according to one embodiment of the present invention. The LUT output data value for each 12-bit data input is computed as follows. The N/2 bits of pixel data for a pixel element in the first image capture is linearized to provide a first pixel data value. The N/2 bits of pixel data for the same pixel element in the second image capture is linearized to provide a second pixel data value. The two linearized pixel data values are subtracted and the resulting value is used as the LUT output data value for the N-bit data input value. For instance, a 6-bit pixel data “010111” from the first image capture is linearized to a first pixel data value of 23 and a 6-bit pixel data “101101” from the second image capture is linearized to a second pixel data value of 45. The two linearized pixel data values are subtracted to yield an output data value of 22. The data value of 22 is stored in an entry 410 LUT 400 where entry 410 is indexed by the 12-bit LUT data input of “010111101101”, as shown in FIG. 11.

By generating a look-up table and using the look-up table to perform the frame differencing operation, the digital imaging system of the present invention can perform ambient light rejection without added computational burden. The frame differencing scheme using a look-up table of the present invention allows the digital imaging system of the present invention to perform ambient light rejection at high speed and without complex circuitry.

The above detailed descriptions are provided to illustrate specific embodiments of the present invention and are not intended to be limiting. Numerous modifications and variations within the scope of the present invention are possible. The present invention is defined by the appended claims.

We claim:

1. A method for generating an ambient light rejected output image comprising:
providing a sensor array including a two-dimensional array of digital pixels, the digital pixels outputting digital signals as digital pixel data representing the image of the scene;
capturing a pair of images of a scene within the time period of a video frame using the sensor array, the pair of images including a first image being illuminated by ambient light and a second image being illuminated by the ambient light and a light source;
storing the digital pixel data associated with the first and second images in a data memory; and
subtracting the first image from the second image to obtain the ambient light rejected output image.

2. The method of claim 1, wherein the time period of a video frame comprises 1/60 seconds.

3. The method of claim 1, wherein subtracting the first image from the second image to obtain the ambient light rejected output image comprises subtracting digital pixel data associated with the first image from digital pixel data associated with the second image on a pixel-by-pixel basis.

4. The method of claim 1, wherein capturing a pair of images of a scene within the time period of a video frame using the sensor array comprises:
capturing the first image of the scene using the sensor array; and
within the same video frame, activating the light source and capturing the second image of the scene using the sensor array.

5. The method of claim 4, wherein the first image is captured before the second image.

6. The method of claim 4, wherein the second image is captured before the first image.

7. The method of claim 4, wherein capturing the first image and capturing the second image each comprises:
resetting the sensor array;
integrating at each digital pixel incident light impinging on the sensor array for a given exposure time; and
generating digital pixel data at each digital pixel corresponding to an analog signal indicative of the light intensity impinging on the digital pixel.

8. The method of claim 1, wherein storing the digital pixel data of the first and second images in a data memory comprises:
storing digital pixel data in M bits for each digital pixel in the first image and the second image.

9. The method of claim 8, wherein subtracting the first image from the second image to obtain the ambient light rejected output image comprises:
providing a look-up table being indexed by an N-bit input data value where N=2M, the look-up table providing data output values indicative of the difference between two M bits digital pixel data;
forming a first input data value by combining an M-bit digital pixel data for a first digital pixel in the first image and an M-bit digital pixel data for the first digital pixel in the second image;
indexing the look-up table using the first input data value; and
obtaining a first data output value associated with the first input data value, the first data output value being indicative of the difference between the M-bit digital pixel data for the first digital pixel in the first image and the M-bit digital pixel data for the first digital pixel in the second image.

10. The method of claim 9, wherein providing a look-up table comprises providing a look-up table being indexed by an N-bit input data value where N=2M, the look-up table providing data output values indicative of the difference between two M bits linearized digital pixel data.

11. The method of claim 1, wherein:
capturing a pair of images of a scene within the time period of a video frame using the sensor array comprises capturing a plurality of pairs of images of a scene within the time period of a video frame using the sensor array, each pair of images including a first image being illuminated by ambient light and a second image being illuminated by the ambient light and a light source;
storing the digital pixel data comprises storing the digital pixel data associated with the plurality of pairs of images in the data memory; and
subtracting the first image from the second image comprises subtracting the first image from the second image for each pair of images to obtain a plurality of difference images and summing the plurality of difference images to obtain the ambient light rejected output image.

12. The method of claim 1, wherein capturing a pair of images of a scene within the time period of a video frame using the sensor array comprises:
capturing the pair of images after a first delay time from the start of each video frame, the first delay time being a pseudo random delay time.

13. The method of claim 1, wherein capturing a pair of images of a scene within the time period of a video frame using the sensor array comprises:
capturing a first image where the entire scene is illuminated by ambient light and a selected portion of the scene is illuminated by a second light source; and
capturing a second image where the entire scene is illuminated by the light source,
wherein when the first image is subtracted from the second image, the ambient rejected output image includes a blacked out portion corresponding to the selected portion of the scene.

14. The method of claim 13, wherein the intensity of the second light source is the same as the intensity of the first light source.

15. A digital imaging system, comprising:
a sensor array including a two-dimensional array of digital pixels, the digital pixels outputting digital signals as digital pixel data representing the image of the scene;
a data memory, in communication with said sensor array, for storing the digital pixel data;
a first processor, in communication with the sensor array and the data memory, for controlling the sensor array and a light source,
wherein the first processor operates the sensor array to capture a first image of a scene being illuminated by ambient light and operates the sensor array and the light source to capture a second image of the scene being illuminated by the ambient light and the light source, the first image and the second image being captured within a video frame, and
wherein the first image is subtracted from the second image to generate an ambient light rejected output image.

16. The digital imaging system of claim 15, wherein the light source comprises a light emitting diode.

17. The digital imaging system of claim 15, wherein the first processor further controls a second light source, the second light source being used to illuminate a selected portion of the scene when the first image is being captured.
